(19) United States
(12) Patent Application Publication
(10) Pub. No.: US 2016/0347908 A1
(43) Pub. Date: Dec. 1, 2016

(54) PROCESS FOR PRODUCING NYLON-6,6

(71) Applicant: BASF SE, Ludwigshafen (DE)

(72) Inventors: Christoph MÜLLER, Mannheim (DE); Matin BOCK, Ludwigshafen (DE); Marion DA SILVA, Mannheim (DE); Rolf-Hartmuth FISCHER, Heidelberg (DE); Benoit BLANK, Edingen-Neckarhausen (DE); Alois KINDLER, Grünstadt (DE); Johann-Peter MELDER, Böhl-lggelheirn (DE); Bernhard OTTO, Schifferstadt (DE); Mathias SCHELWIES, Heidelberg (DE); Andreas HENNINGER, Laumersheim (DE)

(21) Appl. No.: 15/103,468

(22) PCT Filed: Dec. 12, 2014
(86) PCT No.: PCT/EP2014/077566

§ 371 Date: Aug. 16, 2016

(30) Foreign Application Priority Data
Dec. 13, 2013 (EP) 13197154.1

(51) Int. Cl. C08G 69/26; C08G 69/28

(52) U.S. Cl. CPC C08G 69/26; C08G 69/28

(57) ABSTRACT

The present invention relates to a process for producing nylon-6,6 by a) providing a muconic acid starting material selected from muconic acid, esters of muconic acid, lactones of muconic acid and mixtures thereof, b) subjecting the muconic acid starting material provided in step a) at least to some extent to a reaction with hydrogen in the presence of at least one hydrogenation catalyst Hb) to give adipic acid, c1) subjecting the muconic acid starting material provided in step a) to some extent to a reaction with hydrogen in the presence of at least one hydrogenation catalyst Hc1) to give 1,6-hexanediol, or c2) subjecting the adipic acid obtained in step b) to some extent to a reaction with hydrogen in the presence of at least one hydrogenation catalyst Hc2) to give 1,6-hexanediol, d) subjecting the 1,6-hexanediol obtained in step c1) or c2) to amination in the presence of an amination catalyst to obtain hexamethylenediamine, e) subjecting the hexamethylenediamine obtained in step d) and at least a portion of the adipic acid obtained in step b) to polycondensation to obtain nylon-6,6.

### BACKGROUND OF THE INVENTION

The present invention relates to a process for preparing polyamide-6,6 proceeding from muconic acid and/or one of its esters and/or one of its lactones. The present invention further relates to polyamide-6,6 preparable by means of this process.

### STATE OF THE ART

Polyamides are one of the polymers produced on a large scale globally and, in addition to the main fields of use in films, fibers and materials, serve for a multitude of further end uses. Among the polyamides, polyamide-6,6 (Nylon, polyhexamethyleneadipamide) is one of the most extensively produced polymers. Polyamide-6,6 is prepared predominantly by polycondensation of what are called AH salt solutions, i.e. of aqueous solutions comprising adipic acid and 1,6-diaminohexane (hexamethylenediamine) in stoichiometric amounts. Conventional preparation processes for polyamide-6,6 are described, for example, in Kunststoffhandbuch, 3/4 Technische Thermoplaste: Polyamide [Plastics Handbook, 3/4 Industrial Thermoplastics: Polyamides], Carl Hanser Verlag, 1998, Munich, p. 42-71.

All the industrially utilized processes for preparing hexamethylenediamine (HMD) run via adiponitrile (ADN) as an intermediate, which is converted by catalytic hydrogenation to hexamethylenediamine. The methods of greatest economic significance are ADN synthesis proceeding from butadiene and hydrogen cyanide, and the electrodimerization of acrylonitrile, prepared by ammoxidation of propene.

DE 198 00 698 A1 describes biodegradable polyesteramides having polyester and polyamide segments in block form. The polyamide blocks are prepared by conventional means from petrochemical raw materials such as caprolactam or AH salt.

It is known that hexamethylenediamine can be prepared by aminating hydrogenation of hexane-1,6-diol. Until 1981, Celanese used such a process to prepare hexamethylenediamine in a plant having a capacity of about 30 000 tonnes per annum. The amination was effected at 200° C. and 23 mPa with ammonia in the presence of Raney nickel. This achieved HMD yields of about 90%. By-products which occurred were hexamethyleneimine (azepane) and 1,6-aminohexanol. The economic viability of the Celanese process was adversely affected by the preparation of the hexane-1,6-diol in a costly and inconvenient manner by reaction of cyclohexanone with peracetic acid to give caprolactone and subsequent catalytic hydrogenation of the caprolactone.

U.S. Pat. No. 3,215,742 likewise describes a process for preparing alkylenediamines, for example hexamethylenediamine, by reaction of the corresponding diols with ammonia, It is taught that hexamethyleneimine formed as an unwanted by-product can be returned to the aminating hydrogenation stage and converted further to hexamethylenediamine. The hexamethyleneimine can at the same time serve as a solvent for the amination reaction.

U.S. Pat. No. 3,520,933 uses cobalt-, nickel- and/or copper-comprising catalysts for the aminating hydrogenation.

WO 2012/119929 describes, inter alia, the homogeneously catalyzed hydrogenating amination of hexane-1,6-diol to give hexamethylenediamine.

It is known that muconic acid can be used for preparation of alkanedicarboxylic acids and of ε-caprolactam.

WO 2012/141997 describes a process for preparing c-caprolactam, in which muconic acid is reacted with ammonia and hydrogen in the presence of a catalyst. It is likewise stated that this reaction can proceed via an adipic acid intermediate and that the caprolactam obtained can serve for preparation of polyamide-6. The preparation of polyimide-6,6 proceeding from muconic acid is not described in this document.

WO 2010/085712 A2 describes a process for preparing dodecanedicarboxylic acid, in which muconic acid is reduced to hexenedicarboxylic acid and the hexenedicarboxylic acid is reacted with an unsaturated fatty acid in a metathesis reaction.

According to H.-J. Arpe, Industrielle Organische Chemie [Industrial Organic Chemistry], 6th edition (2007), Wiley-UCH-Verlag, pages 267 and 270, hexane-1,6-diol can be prepared by hydrogenation of adipic acid or adipic diesters in the presence of Cu catalysts, Co catalysts or Mn catalysts. The synthesis is effected at a temperature of 170 to 240° C. and a pressure of 5 to 30 MPa. Hexane-1,6-diol can also be obtained by catalytic hydrogenation of caprolactone.

WO 99/25672 describes a process for preparing hexane-1,6-diol and 6-hydroxycaproic acid or esters thereof by catalytic hydrogenation of adipic acid, adipic monoesters or adipic diesters, wherein the bottom product obtained in the distillation of the hydrogenation output after removal of the hexane-1,6-diol and the hydroxycaproic acid, comprising essentially oligomeric esters of 6-hydroxycaproic acid, is recycled into the hydrogenation.

EP 883 590 B1 discloses the use of a carboxylic acid mixture (DCS) rather than pure adipic acid or adipic esters prepared from pure adipic acid. This is obtained as a by-product in the oxidation of cyclohexane with oxygen or oxygen-comprising gases and by water extraction of the reaction mixture. The extract comprises adipic acid and 6-hydroxycaproic acid as main products, and additionally a multitude of mono- and dicarboxylic acids. The carboxylic acids are esterified with a lower alcohol. Adipic diesters are separated by distillation from the esterification mixture and hydrogenated catalytically to hexane-1,6-diol.

It is advantageous in this context that the DCS waste product is very inexpensive compared to pure adipic acid. On the other hand, a considerable level of distillation complexity is necessary to produce pure hexane-1,6-diol. Particular difficulties are presented by the distillative removal of the cyclohexane-1,4-diols which occur as by-products.

Adipic acid is conventionally synthesized by oxidation of cyclohexanol or cyclohexanone proceeding from benzene. It can also be obtained in an environmentally friendly manner from biogenic sources.

U.S. Pat. No. 4,968,612 describes a fermentation process for preparation of muconic acid and the hydrogenation of the muconic acid thus obtained to adipic acid. Specifically, muconic acid is reacted as a 40% by weight slurry in acetic acid and in the presence of a palladium catalyst on charcoal. The water content of the acetic acid used is unspecified. A disadvantage of this mode of reaction is the use of corrosive acetic acid, which entails the use of high-quality corrosion-resistant reactors.

K. M. Draths and J. W. Frost, J. Am. Chem. Soc. 1994, 116, 399-400 and W. Niu et al., Biotechnol. Prog. 2002, 18, 201-211 describe the preparation of cis,cis-muconic acid from glucose by biocatalyzed synthesis with subsequent hydrogenation of the cis,cis-muconic acid with the aid of a platinum catalyst to adipic acid. In the two cases, the pH of the fermentation mixture prior to the hydrogenation is adjusted to above 6.3, or to a value of 7.0. This results in a solution of muconic salts. This document does not may anything about the preparation of hexamethylenediamine and polyamide-6,6.

A further process for preparing muconic acid from renewable sources is described, for example, in WO 2010/148080 A2. According to example 4, in paragraphs [0065] and

of this document, 15 g of cis,cis-muconic acid and 150 ml of water are heated under water reflux for 15 minutes. After cooling to room temperature, filtration and drying, 10.4 g (69%) of cis,trans-muconic acid are obtained. The mother liquor (4.2 g=28% by weight, based on cis,cis-muconic acid) no longer consists of muconic acid. It comprises lactones and further, unknown reaction products.

J. M. Thomas et al., Chem. Commun. 2003, 1126-1127, describes the hydrogenation of muconic acid to adipic acid with the aid of bimetallic nanocatalysts which have been intercalated into the pores of a mesoporous silicon dioxide by means of specific anchor groups, in pure ethanol.

J. A. Elvidge et al., J. Chem. Soc. 1950, 2235-2241, describe the preparation of cis,trans-muconic acid and the hydrogenation thereof to adipic acid in ethanol in the presence of a platinum catalyst. No details are given of the amount of solvent used and the catalyst.

X. She et al., ChemSusChem 2011, 4, 1071-1073, describe the hydrogenation of trans,trans-muconic acid to adipic acid with rhenium catalysts on a titanium dioxide support in solvents selected from methanol, ethanol, 1-butanol, acetone, toluene and water. The hydrogenations are performed exclusively at an elevated temperature of 120° C. With the catalyst used, only a low selectivity based on the adipic acid is achieved; the main product is dihydromuconic acid.

WO 2010/141499 describes the oxidation of lignin to vanillic acid, the decarboxylation of the latter to 2-methoxyphenol and further conversion to catechol, and finally oxidation to muconic acid, and hydrogenation of muconic acid obtained in this way with various transition metal catalysts to adipic acid. The solvent used for the hydrogenation is unspecified.

EP 0117048 A2 describes a process for preparing nylon-6,6 salt, in which toluene is converted by fermentation in the presence of hexamethylenediamine to muconic acid, giving a fermentation medium comprising hexamethylenediamine muconate. The microorganisms are separated from this fermentation medium and the hexamethylene-diamine muconate is hydrogenated to hexamethylenediamine adipate. The nylon-6,6 salt thus obtained can be used for preparation of polyimide-6,6. A disadvantage of this process is that toluene that does not originate from renewable sources is used as the starting material. It is additionally an essential feature of this process that, for the hydrogenation, a salt of muconic acid with the diamine used for amide formation is used. The hydrogenation of free muconic acid or a muconic ester to adipic acid is not described in this document.

US 2012/0196339 describes the preparation of industrially relevant compounds from prokaryotic organisms. For instance, proceeding from dehydroshikimate, it is possible to prepare cis,cis-muconic acid and convert it further to adipic acid. Only in the context of drawing 1A is the further conversion to nylon-6,6 shown. However, this document does not contain the slightest hint to produce the second component in the nylon-6,6 production, the hexamethylenediamine, from a renewable raw material as well. More particularly, there is thus no hint at all as to how the production of adipic acid and of hexamethylenediamine can be integrated into a single process proceeding from muconic acid. With regard to the hydrogenation of the cis,cis-muconic acid to adipic acid and the isolation and/or purification thereof too, the teaching of this document is completely unclear. For instance, paragraph [0150] on page 17 of US 2012/0196339 does give a general mention of the hydrogenation of muconic acid to adipic acid. However, there is no mention either of a suitable solvent for the hydrogenation reaction or of any purification of the adipic acid by recrystallization.

WO 2012/141993 A1 describes the preparation of hexamethylenediamine (HMDA) from muconic diesters, wherein the muconic diesters are amidated in a first step and then reduced directly to HMDA (route 1) or, after the amidation, are dehydrated to give nitriles and then hydrogenated to give HMDA (route 2) or, after the amidation, are hydrogenated to give adipamide, dehydrated to give adiponitrile and then hydrogenated to give HMDA (route 3). This process has several disadvantages. For instance, the amidation with ammonia has to be conducted at room temperature and takes 4 to 14 hours, giving the diamide only in moderate yield. A further disadvantage is that, for the elimination of water, auxiliaries such as POCl₃ and P₂O₅ are needed. It was possible to overcome these disadvantages by the process of the invention, according to which hexamethylenediamine is prepared by hydrogenation of muconic acid or adipic acid to give hexane-1,6-diol and the catalytic amination thereof. Moreover, in the process described in WO 2012/141993 A1, only hexamethylenediamine and not adipic acid is produced from renewable raw materials.

It is an object of the present invention to provide an economically viable process for preparing polyamide-6,6. More particularly, this process is not to proceed from petrochemical C₆ starting materials, but from C₆ starting materials preparable from renewable raw materials. At the same time, the polyamide-6,6 is to be made available in high yield and purity.

It has now been found that, surprisingly, this object is achieved by subjecting a muconic acid starting material selected from muconic acid, esters of muconic acid, lactones of muconic acid and mixtures thereof to a conversion to adipic acid on the one hand, and to hexamethylenediamine on the other. In this context, the lactones of muconic acid are especially suitable for preparation of hexane-1,6-diol, which can serve in accordance with the invention as an important intermediate for preparation of hexamethylenediamine. More particularly, the muconic acid used originates from renewable (biogenic) sources.

### SUMMARY OF THE INVENTION

The invention firstly provides a process for preparing polyamide-6,6, in which
a) a muconic acid starting material is provided, selected from muconic acid, esters of muconic acid, lactones of muconic acid and mixtures thereof,
b) the muconic acid starting material provided in step a) is at least partly subjected to a reaction with hydrogen in the presence of at least one hydrogenation catalyst Hb) to adipic acid,
c1) the muconic acid starting material provided in step a) is partly subjected to a reaction with hydrogen in the presence of at least one hydrogenation catalyst Hc1) to hexane-1,6-diol,
or
c2) the adipic acid obtained in step b) is partly subjected to a reaction with hydrogen in the presence of at least one hydrogenation catalyst Hc2) to hexane-1,6-diol,
d) the hexane-1,6-diol obtained in step c1) or c2) is subjected to an amination in the presence of an amination catalyst to obtain hexamethylenediannine,
e) at least a portion of the adipic acid obtained in step b) and the hexamethylenediamine obtained in step d) are subjected to a polycondensation to obtain polyamide-6,6.

The invention further provides a polyamide-6,6 having a C¹⁴/C¹² isotope ratio in the range from 0.5×10⁻¹² to 5×10⁻¹².

The invention further provides polyamide-6,6 preparable proceeding from muconic acid synthesized from at least one renewable raw material.

Specifically, the muconic acid starting material provided in step a) does nto comprise any salts of muconic acid.

In a specific embodiment, the hydrogenation in at least one of steps b) and/or c1) and/or c2) is effected in the liquid phase in the presence of water as a solvent. In an even more specific embodiment, the hydrogenation in at least one of steps b) and/or c1) and/or c2) is effected in the liquid phase in the presence of water as the sole solvent.

It has been found that, surprisingly, muconic acid can be hydrogenated in aqueous solvents and specifically in water as the sole solvent in high yields to give adipic acid and to give hexane-1,6-diol. Specifically the high adipic acid yields are surprising, since significantly lower yields were to be expected in the light of the prior art. For instance, it is known from example 4 of WO 2010/148080 that, when muconic acid is heated in the presence of water, i.e. under conditions as also exist in the hydrogenation of cis,cis-muconic acid (except without hydrogen and catalyst), there is isomerization to give cis,trans-muconic acid (69% yield) and further reaction thereof to give an internal lactone (25% yield) and hydrolysis and decarboxylation thereof to give levulinic acid (3% yield). With regard to these results, the achievement of such a high adipic acid yield in the process of the invention was not to be expected.

Muconic acid (hexadiene-2,4-dicarboxylic acid) exists in three stereoisomeric forms, the cis,cis form, the cis,trans form and the trans,trans form, which may be present as a mixture. All three forms are crystalline compounds having high melting points (decomposition); see, for example, Römpp Chemie Lexikon, 9th edition, volume 4, page 2867. It has been found that hydrogenation of muconic acid melts is barely possible by industrial means, since the very particularly preferred hydrogenation temperatures are well below the melting points. Therefore, an inert solvent having maximum solubility for muconic acid would be desirable for the hydrogenation. At first glance, water appears unsuitable to the person skilled in the art as a solvent, since muconic acid, in contrast to adipic acid, is sparingly soluble within the temperature range from 20 to 100° C. As described above, WO 2010/148080 teaches that cis,trans-muconic acid is obtained in only 69% yield when cis,cis-muconic acid is heated in water under reflux with subsequent crystallization. The remaining mother liquor no longer consists of muconic acid, but comprises lactones and further, unknown reaction products. On the basis of these results, the person skilled in the art, in the hydrogenation of muconic acid suspended in water, in accordance with a preferred embodiment of the present invention, would have expected much lower adipic acid yields.

### Embodiments of the Invention

Specifically, the invention encompasses the following preferred embodiments:
1. A process for preparing polyamide-6,6, in which
   a) a muconic acid starting material is provided, selected from muconic acid, esters of muconic acid, lactones of muconic acid and mixtures thereof,
   b) the muconic acid starting material provided in step a) is at least partly subjected to a reaction with hydrogen in the presence of at least one hydrogenation catalyst Hb) to adipic acid,
   c1) the muconic acid starting material provided in step a) is partly subjected to a reaction with hydrogen in the presence of at least one hydrogenation catalyst Hc1) to hexane-1,6-diol,
   or
   c2) the adipic acid obtained in step b) is partly subjected to a reaction with hydrogen in the presence of at least one hydrogenation catalyst Hc2) to hexane-1,6-diol,
   d) the hexane-1,6-diol obtained in step c1) or c2) is subjected to an amination in the presence of an amination catalyst to obtain hexamethylenediamine,
   e) at least a portion of the adipic acid obtained in step b) and the hexamethylenediamine obtained in step d) are subjected to a polycondensation to obtain polyamide-6,6.
2. The process according to embodiment 1, wherein a muconic acid starting material is provided in step a), in which the muconic acid originates from a renewable source, and is preferably prepared by biocatalytic synthesis from at least one renewable raw material.
3. The process according to embodiment 1 or 2, wherein the muconic acid used in step a) has a ¹⁴C-to-¹²C isotope ratio in the range from 0.5×10⁻¹² to 5×10⁻¹².
4. The process according to any of embodiments 1 to 3, wherein the hydrogenation in step b) and/or in step c1) is effected using a muconic acid starting material selected from muconic acid, muconic monoesters, muconic diesters, poly(muconic esters) and mixtures thereof.
5. The process according to any of embodiments 1 to 3, wherein the hydrogenation in step c1) is effected using a muconic acid starting material selected from the lactones (III), (IV) and (V) and mixtures thereof:

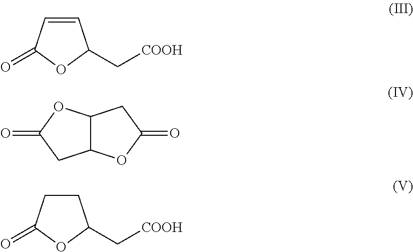

6. The process according to any of embodiments 1 to 5, wherein the hydrogenation catalyst Hb) is selected from Raney cobalt, Raney nickel and Raney copper.
7. The process according to any of embodiments 1 to 6, wherein the hydrogenation in step b) is effected at a temperature within the range from 50 to 160° C.
8. The process according to any of embodiments 1 to 7, wherein the hydrogenation in step c1) is effected in the liquid phase in the presence of a solvent selected from water, aliphatic C₁ to C₅ alcohols, aliphatic C₂ to C₆ diols, ethers and mixtures thereof.
9. The process according to any of embodiments 1 to 7, wherein the hydrogenation in step c1) is effected in the liquid phase in the presence of water as the sole solvent.
10. The process according to any of embodiments 1 to 7, wherein the hydrogenation in step c1) is effected using a muconic diester selected from compounds of the general formula (II):

R¹OOC—CH═CH—CH═CH—COOR² (II)
in which the R¹ and R² radicals are each independently straight-chain or branched C₁-C₅-alkyl,
wherein the hydrogenation in step c1) is effected in the gas phase.
11. The process according to any of the preceding embodiments, wherein the hydrogenation catalyst Hc1) used in step c1) is a homogeneous or heterogeneous transition metal catalyst, preferably a heterogeneous transition metal catalyst.
12. The process according to any of embodiments 1 to 11, wherein in step c1) a muconic acid starting material is used, selected from muconic acid, muconic monoesters, lactones of muconic acid and mixtures thereof, and the hydrogenation catalyst Hc1) comprises at least 50% by weight of cobalt, ruthenium or rhenium, based on the total weight of the reduced catalyst.
13. The process according to any of embodiments 1 to 11, wherein in step c1) a muconic acid starting material is used, selected from muconic diesters, poly(muconic esters) and mixtures thereof, and the hydrogenation catalyst Hc1) comprises at least 50% by weight of copper, based on the total weight of the reduced catalyst.
14. The process according to any of the preceding embodiments, wherein the hydrogenation catalyst Hc2) used in step c2), based on the total weight of the reduced catalyst, comprises at least 50% by weight of elements selected from rhenium, iron, ruthenium, cobalt, rhodium, iridium, nickel and copper.
15. The process according to any of the preceding embodiments, wherein the hydrogenation in step c2) is effected at a temperature within the range from 160 to 240° C.
16. The process according to any of the preceding embodiments, wherein adipic acid-containing water which is obtained in the isolation of the hydrogenation catalyst Hc2) on completion of step c2) is used as solvent in step b).
17. The process according to any of the preceding embodiments, wherein the hydrogenation in step b) and/or the hydrogenation in step c1) and/or the hydrogenation in step c2) is conducted in n series-connected hydrogenation reactors, where n is an integer of at least two,
18. The process according to embodiment 17, wherein the 1st to (n-1)th reactor has a stream from the reaction zone conducted within an external circuit.
19. The process according to either of embodiments 17 and 18, wherein the hydrogenation is conducted adiabatically in the nth reactor.
20. The process according to any of the preceding embodiments, wherein the hexane-1,6-diol obtained in step c1) or in step c2) is reacted in step d) with ammonia in the presence of the amination catalyst to give hexamethylenediamine.
21. The process according to any of the preceding embodiments, wherein the amination in step d) is conducted without or with supply of hydrogen.
22. The process according to any of the preceding embodiments, wherein the reaction output from the amination in step d) is subjected to a separation to obtain a hexamethyleneimine-enriched and a hexamethylenediamine-depleted fraction.
23. The process according to embodiment 22, wherein the hexamethyleneimine-enriched fraction is recycled into the amination in step d).
24. The process according to any of the preceding embodiments, wherein hexamethyleneimine is used as the sole solvent in step d).
25. Polyamide-6,6 having a C¹⁴/C¹² isotope ratio in the range from 0.5×10⁻¹² to 5×10⁻¹².
26. Polyamide-6,6 preparable proceeding from muconic acid synthesized biocatalytically from at least one renewable raw material.

### DETAILED DESCRIPTION OF THE INVENTION

In the context of the present invention, esters of muconic acid refer to the esters with a separate (external) alcohol component. Lactones of muconic acid are understood to mean the compounds (III) and (IV) obtainable by intramolecular Michael addition, and the product (V) of the hydrogenation of the compound (III):

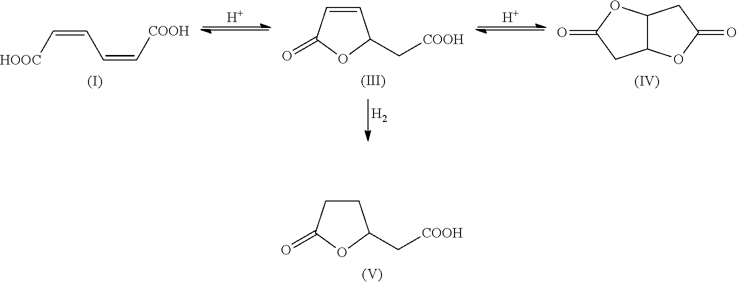

The lactone (V) can also form through intramolecular Michael addition from dihydromuconic acid.

Step a)

The muconic acid provided in step a) of the process according to the invention preferably originates from renewable sources. In the context of the invention, this is understood to mean natural (biogenic) sources and not fossil sources such as mineral oil, natural gas and coal. Preferably, the muconic acid provided in step a) of the process according to the invention originates from carbohydrates, e.g. starch, cellulose and sugars, or from lignin. Compounds obtained from renewable sources, for example muconic acid, have a different ¹⁴C-to-¹²C isotope ratio than compounds obtained from fossil sources such as mineral oil. The muconic acid used in step a) accordingly preferably has a ¹⁴C-to-¹²C isotope ratio in the range from 0.5×10⁻¹² to 5×10⁻¹².

The preparation of muconic acid from renewable sources can be effected by all processes known to those skilled in the art, preferably by biocatalytic means. The biocatalytic preparation of muconic acid from at least one renewable raw material is described, for example, in the following documents: U.S. Pat. No. 4,968,612, WO 2010/148063 A2, WO 2010/148080 A2, and also K. M. Draths and J. W. Frost, J. Am. Chem. Soc. 1994, 116, 339-400 and W. Niu et al., Biotechnol. Prog. 2002, 18, 201-211.

As explained above, muconic acid (hexadiene-2,4-dicarboxylic acid) exists in three isomeric forms, the cis,cis form, the cis,trans form and the trans,trans form, which may be present as a mixture. The term “muconic acid” in the context of the invention encompasses the different conformers of muconic acid in any composition. Suitable feedstocks for the reaction with hydrogen in step b) and/or in step c1) of the process according to the invention are in principle all conformers of muconic acid and/or esters thereof and any mixtures thereof.

In a preferred embodiment, in step a) of the process according to the invention, a muconic acid starting material enriched in cis,trans-muconic acid and/or esters thereof or consisting of cis,trans-muconic acid and/or esters thereof is provided. This is because cis,trans-muconic acid and esters thereof have a higher solubility in water and in organic media than cis,cis-muconic acid and trans,trans-muconic acid. If, in step a) of the process according to the invention, a muconic acid starting material comprising at least one component selected from cis,cis-muconic acid, trans,trans-muconic acid and/or esters thereof is provided, this muconic acid starting material, before or during the hydrogenation in step b) or step c1) can be subjected to an isomerization to cis,trans-muconic acid or esters thereof. The isomerization of cis,cis-muconic acid to cis,trans-muconic acid is depicted in the following scheme:

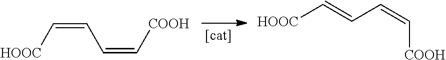 [SMILES: O=C(O)/C=C\C=C/C(=O)O ; O=C(O)/C=C\C=C\C(=O)O]

Useful catalysts are especially inorganic or organic acids, hydrogenation catalysts, iodine or UV radiation. Suitable hydrogenation catalysts are described hereinafter. The isomerization can be effected, for example, by processes described in WO 2011/085311 A1.

Preferably, the feedstock for the reaction with hydrogen in step b) and/or in step c1) consists to an extent of at least 80% by weight, more preferably at least 90% by weight, of cis,trans-muconic acid and/or esters thereof, based on the total weight of all the muconic acid and muconic ester conformers present in the feedstock.

For the hydrogenation in step b) and/or in step c1), preference is given to using a muconic acid starting material selected from muconic acid, muconic monoesters, muconic diesters, poly(muconic esters) and mixtures thereof. For the hydrogenation in step b), it is also possible to use lactones of muconic acid. In the context of the present invention, the term “muconic polyester” also refers to oligomeric muconic esters having at least one repeat unit derived from muconic acid or the diol used to form the ester, and at least two complementary repeat units bonded via carboxylic ester groups.

Preferably, the muconic monoester used is at least one compound of the general formula (I)

R¹OOC—CH═CH—CH═CH—COOH (I)

in which the R¹ radicals are each independently straight-chain or branched C₁-C₅-alkyl.

Preferably, the muconic diester used is at least one compound of the general formula (II)

R¹OOC—CH═CH—CH═CH—COOR² (II)

in which the R¹ and R² radicals are each independently straight-chain or branched C₁-C₅-alkyl.

Preferably, the poly(muconic ester) used is at least one compound of the general formula (VI)

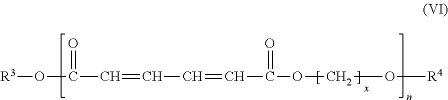

in which
x is an integer from 2 to 6,
o is an integer from 1 to 100,
R³ is H, straight-chain or branched C₁-C₅-alkyl or a HO—(CH₂)ₓ— group,
R⁴ is H or a —C(═O)—CH═CH—CH═CH—COOR⁵ group in which R⁵ is H or straight-chain or branched C₁-C₅-alkyl,

with the proviso that, when n=1, either R³ is H and R⁴ is —C(═O)—CH═CH—CH═CH—COOR⁵ or R³ is a HO—(CH₂)ₓ— group and R⁴ is H.

In the context of the invention, the degree of polymerization of the poly(muconic ester) refers to the sum total of repeat units derived in a formal sense from muconic acid and of the repeat units derived in a formal sense from diols HO—(CH₂)ₓ—OH.

In a first preferred embodiment, the hydrogenation in step b) and/or in step c1) is effected using a muconic acid starting material selected from muconic acid, muconic monoesters, muconic diesters, poly(muconic esters) and mixtures thereof.

In a second preferred embodiment, the hydrogenation in step b) is effected using a muconic acid starting material selected from the lactones (III), (IV) and (V) and mixtures thereof:

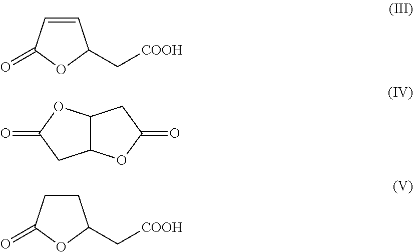

In a first preferred embodiment, the hydrogenation in step b) and/or in step c1) is effected using a muconic acid starting material selected from muconic acid, muconic monoesters, muconic diesters, poly(muconic esters) and mixtures thereof, and the hydrogenation is effected in the liquid phase.

Hydrogenation Steps b), c1) and c2)

In a first embodiment of the process according to the invention, the hydrogenation in step b) and/or in step c1) and/or in step c2) is effected in the liquid phase in the presence of a solvent selected from water, aliphatic C₁ to C₅ alcohols, aliphatic C₂ to C₆ diols, ethers and mixtures thereof. Preferably, the solvent is selected from water, methanol, ethanol, n-propanol, isopropanol, n-butanol, sec-butanol, i-butanol and tert-butanol, ethylene glycol, propane-1,3-diol, butane-1,4-diol, pentane-1,5-diol, hexane-1,6-diol, tetrahydrofuran, 2-methyltetrahydrofuran, diethyl ether, methyl tert-butyl ether and mixtures thereof. Preference is given to aliphatic C₁ to C₅ alcohols, water and mixtures of these solvents. Particular preference is given to methanol, n-butanol, isobutanol, water and mixtures of these solvents. It is additionally preferable to use the hexane-1,6-diol target product as the solvent. In this case, hexane-1,6-diol can be used alone or in a mixture with alcohols and/or water.

It is preferable that, for the hydrogenation in the liquid phase in step b) and/or in step c1), a solution comprising 10 to 60% by weight of muconic acid or one of its esters, more preferably 20 to 50% by weight, most preferably 30 to 50% by weight, is used.

In a second preferred embodiment, the hydrogenation in step b) and/or c1) is effected using at least muconic diester of the general formula (II)

R¹OOC—CH═CH—CH═CH—COOR² (II)

in which the R¹ and R² radicals are each independently straight-chain or branched C₁-C₅-alkyl, and wherein the hydrogenation is effected in the gas phase.

Hydrogenation catalysts suitable for the reaction in steps b), c1) and c2) are in principle the transition metal catalysts known to the person skilled in the art for hydrogenation of carbon-carbon double bonds. In general, the catalyst comprises at least one transition metal of groups 7, 8, 9, 10 and 11 of the IUPAC Periodic Table. Preferably, the catalyst has at least one transition metal from the group of Mn, Re, Fe, Ru, Co, Rh, Ir, Ni, Pd, Pt, Cu and Au. More preferably, the catalyst has at least one transition metal from the group of Co, Ni, Cu, Re, Fe, Ru, Rh, Ir. The hydrogenation catalysts consist of the transition metals mentioned as such or comprise the transition metals mentioned applied to a support, as precipitated catalysts, as Raney catalysts or as mixtures thereof.

Inert support materials used for the hydrogenation catalysts used in accordance with the invention in steps b), c1) and c2) may be virtually all prior art support materials as used advantageously in the production of supported catalysts, for example carbon, SiO₂ (quartz), porcelain, magnesium oxide, tin dioxide, silicon carbide, TiO₂ (rutile, anatase), Al₂O₃ (alumina), aluminum silicate, steatite (magnesium silicate), zirconium silicate, cerium silicate or mixtures of these support materials. Preferred support materials are carbon, aluminum oxide and silicon dioxide. A particularly preferred support material is carbon. The silicon dioxide support materials used for catalyst production may be silicon dioxide materials of different origin and production, for example fumed silicas or silicas produced by wet-chemical means, such as silica gels, aerogels or precipitated silicas (for production of the various SiO₂ starting materials see: W. Büchner, R. Schliebs, G. Winter, K. H. Büchel: Industrielle Anorganische Chemie [Industrial Inorganic Chemistry], 2nd ed., p. 532-533, VCH Verlagsgesellschaft, Weinheim 1986).

The hydrogenation catalysts can be used in the form of shaped bodies, for example in the form of spheres, rings, cylinders, tubes, cuboids or other geometric bodies. Unsupported catalysts can be shaped by customary methods, for example by extrusion, tableting etc. The shape of supported catalysts is determined by the shape of the support. Alternatively, the support can be subjected to a shaping process before or after the application of the catalytically active component(s). The transition metal catalysts C can be used, for example, in the form of pressed cylinders, tablets, pellets, wagonwheels, rings, stars, or extrudates such as solid extrudates, polylobal extrudates, hollow extrudates and honeycombs, or other geometric bodies.

The catalyst particles generally have a mean (greatest) diameter of 0.5 to 20 mm, preferably 1 to 10 mm. These include, for example, transition metal catalysts K in the form of tablets, for example having a diameter of 1 to 7 mm, preferably 2 to 6 mm, and a height of 3 to 5 mm, rings having external diameter, for example, 4 to 7 mm, preferably 5 to 7 mm, height 2 to 5 mm and hole diameter 2 to 3 mm, or extrudates of different length with diameter, for example, 1.0 to 5 mm. Shapes of this kind can be obtained in a manner known per se by tableting or extrusion. For this purpose, it is possible to add customary auxiliaries to the catalyst composition, for example lubricants such as graphite, polyethylene oxide, cellulose or fatty acids (such as stearic acid) and/or shaping auxiliaries and reinforcing agents, such as fibers of glass, asbestos or silicon carbide.

The catalyst may also be present in the form either of a homogeneous or heterogeneous catalyst under the hydrogenation conditions. Preferably, the catalyst is in the form of a heterogeneous catalyst under the hydrogenation conditions. Specifically, the catalyst is in the form of a heterogeneous catalyst under the hydrogenation conditions in at least one of steps b) and/or c1) and/or c2). Even more specifically, the catalyst is in the form of a heterogeneous catalyst under the hydrogenation conditions in each of steps b) and/or c1) and/or c2).

If a heterogeneous catalyst is used, it may be applied, for example, to a support in mesh form. Alternatively or additionally, the heterogeneous catalyst may be applied to the inner wall of a tubular support, in which case the reaction mixture flows through the tubular support. Alternatively or additionally, the catalyst can be used in the form of a particulate solid.

In a preferred embodiment, the hydrogenation in at least one of steps b), c1) and c2) is effected in the liquid phase, and the catalyst is in the form of a suspension. In a specific embodiment, the hydrogenation in each of steps b), c1) and c2) is effected in the liquid phase, and the catalyst is in the form of a suspension. If a liquid reaction output is removed from the reaction zone, the suspended catalyst can be kept in the reaction zone by retention methods known to those skilled in the art. These retention methods preferably include crossflow filtration, gravitational filtration and/or filtration by means of at least one filter cartridge.

In a specific execution of the process according to the invention, the hydrogenation in at least one of steps b), c1) and c2) is effected in n series-connected hydrogenation reactors, where n is an integer of at least 2. Suitable values of n are 2, 3, 4, 5, 6, 7, 8, 9 and 10. Preferably, n is 3 to 6 and especially 2 or 3. In this execution, the hydrogenation is preferably effected continuously.

The reactors used for hydrogenation may each independently have one or more reaction zones within the reactor. The reactors may be identical or different reactors. These may, for example, each have the same or different mixing characteristics and/or be divided once or more than once by internals.

Suitable pressure-resistant reactors for the hydrogenation are known to those skilled in the art. These include the reactors generally customary for gas-liquid reactions, for example tubular reactors, shell and tube reactors, gas circulation reactors, bubble columns, loop apparatuses, stirred tanks (which may also be configured as stirred tank cascades), airlift reactors etc.

The process according to the invention using heterogeneous hydrogenation catalysts can be conducted in fixed bed mode or suspension mode. Operation in fixed bed mode can be conducted, for example, in liquid phase mode or in trickle mode. In this case, the hydrogenation catalysts are preferably used in the form of shaped bodies as described above, for example in the form of pressed cylinders, tablets, pellets, wagonwheels, rings, stars, or extrudates such as solid extrudates, polylobal extrudates, hollow extrudates, honeycombs etc.

In suspension mode, heterogeneous catalysts are likewise used. The heterogeneous catalysts are usually used in a finely divided state and are in fine suspension in the reaction medium.

Suitable heterogeneous catalysts and processes for preparation thereof have been described above.

In the case of hydrogenation over a fixed bed, a reactor with a fixed bed arranged in the interior thereof, through which the reaction medium flows, is used. This fixed bed may be formed from a single bed or from a plurality of beds. Each bed may have one or more zones, at least one of the zones comprising a material active as a hydrogenation catalyst. Each zone may have one or more different catalytically active materials and/or one or more different inert materials. Different zones may each have identical or different compositions. It is also possible to provide a plurality of catalytically active zones separated from one another, for example, by inert beds. The individual zones may also have different catalytic activity. To this end, it is possible to use different catalytically active materials and/or to add an inert material at least to one of the zones. The reaction medium which flows through the fixed bed comprises at least one liquid phase. The reaction medium may also additionally comprise a gaseous phase.

The reactors used in the hydrogenation in suspension are especially loop apparatuses such as jet loops or propeller loops, stirred tanks, which may also be configured as stirred tank cascades, bubble columns or airlift reactors.

Preferably, the continuous hydrogenation in at least one of steps b), c1) and/or c2) is effected in at least two series-connected fixed bed reactors. The reactors are preferably operated in cocurrent. The feed streams can be fed in either from the top or from the bottom.

If desired, in a hydrogenation apparatus composed of n reactors, at least two of the reactors (i.e. 2 to n of the reactors) may have different temperatures. In a specific embodiment, every downstream reactor is operated with a higher temperature than the previous reactor. In addition, each of the reactors may have two or more reaction zones with different temperatures. For example, a different temperature, preferably a higher temperature, can be established in a second reaction zone than in the first reaction zone, or a higher temperature than in an upstream reaction zone can be established in every downstream reaction zone, for example in order to achieve substantially full conversion in the hydrogenation.

If desired, in a hydrogenation apparatus composed of n reactors, at least two of the reactors (i.e. 2 to n of the reactors) may have different pressures. In a specific embodiment, every downstream reactor is operated with a higher pressure than the previous reactor.

The hydrogen required for the hydrogenation can be fed into the first and optionally additionally into at least one further reactor. Preferably, hydrogen is fed only into the first reactor. The amount of hydrogen fed to the reactors is calculated from the amount of hydrogen consumed in the hydrogenation reaction and any amount of hydrogen discharged with the offgas.

The proportion of compound to be hydrogenated which has been converted in the particular reactor can be adjusted, for example, via the reactor volume and/or the residence time in the reactor.

To remove the heat of reaction which arises in the exothermic hydrogenation, it is possible to provide one or more of the reactors with at least one cooling apparatus. In a specific embodiment, at least the first reactor is provided with a cooling apparatus. The heat of reaction can be removed by cooling of an external circulation stream or by internal cooling in at least one of the reactors. For the internal cooling, it is possible to use the apparatus customary for this purpose, generally hollow modules such as Field tubes, tube coils, heat exchanger plates, etc. Alternatively, the reaction can also be effected in a cooled shell and tube reactor.

Preferably, the hydrogenation is effected in n series-connected hydrogenation reactors, where n is an integer of at least two, and wherein at least one reactor has a stream from the reaction zone conducted within an external circuit (external circulation stream, liquid circulation system, loop mode). Preferably, n is two or three.

Preferably, the hydrogenation is effected in n series-connected hydrogenation reactors, where n is preferably two or three, and the 1st to (n-1)th reactor has a stream from the reaction zone conducted within an external circuit.

Preferably, the hydrogenation is effected in n series-connected hydrogenation reactors, where n is preferably two or three, and wherein the reaction is conducted adiabatically in the nth reactor (the last reactor through which the reaction mixture to be hydrogenated flows).

Preferably, the hydrogenation is effected in n series-connected hydrogenation reactors, where n is preferably two or three, and wherein the nth reactor is operated in straight pass.

If a reactor is operated “in straight pass”, this shall be understood here and hereinafter to mean that a reactor is operated without recycling of the reaction product in the manner of a loop mode of operation. The mode of operation in straight pass does not fundamentally rule out backmixing internals and/or stirring units in the reactor.

When the reaction mixture hydrogenated in one of the reactors connected downstream of the first reactor (i.e. in the 2nd to nth reactor) has only such low proportions of hydrogenatable muconic acid that the exothermicity occurring in the reaction is insufficient to maintain the desired temperature in the reactor, heating of the reactor (or of individual reaction zones of the second reactor) may also be required. This can be effected analogously to the above-described removal of the heat of reaction by heating an external circulation stream or by internal heating. In a suitable embodiment, the temperature of a reactor can be controlled by using the heat of reaction from at least one of the upstream reactors.

In addition, the heat of reaction withdrawn from the reaction mixture can be used to heat the feed streams to the reactors. For this purpose, for example, the feed stream of the compound to be hydrogenated into the first reactor can be mixed at least partly with an external circulation stream of this reactor and then the combined streams can be conducted into the first reactor. In addition, in the case of m=2 to n reactors, the feed stream from the (m-1)th reactor can be mixed in the mth reactor with a circulation stream of the mth reactor, and the combined streams can then be conducted into the mth reactor. In addition, the feed stream of the compound to be hydrogenated and/or another feed stream can be heated with the aid of a heat exchanger which is operated with heat of hydrogenation withdrawn.

In a specific configuration of the process, a reactor cascade composed of n series-connected reactors is used, in which case the reaction is performed adiabatically in the nth reactor. In the context of the present invention, this term is used in the technical and not in the physicochemical sense. Thus, the reaction mixture generally experiences a temperature increase as it flows through the second reactor owing to the exothermic hydrogenation reaction. An adiabatic reaction regime is understood to mean a procedure in which the amount of heat released in the hydrogenation is absorbed by the reaction mixture in the reactor and no cooling by cooling apparatuses is employed. The heat of reaction is thus removed from the second reactor with the reaction mixture, apart from a residual fraction which is released to the environment by natural heat conduction and heat emission from the reactor. The nth reactor is preferably operated in straight pass.

In a preferred embodiment, the hydrogenation is effected using a two-stage reactor cascade, in which case the first hydrogenation reactor has a stream from the reaction zone conducted within an external circuit. In a specific embodiment of the process, a reactor cascade composed of two series-connected reactors is used, in which case the reaction is performed adiabatically in the second reactor.

In a further preferred embodiment, the hydrogenation is effected using a three-stage reactor cascade, in which case the first and second hydrogenation reactor have a stream from the reaction zone conducted within an external circuit. In a specific embodiment of the process, a reactor cascade composed of three series-connected reactors is used, in which case the reaction is performed adiabatically in the third reactor.

In one embodiment, additional mixing can be effected in at least one of the reactors used. Additional mixing is especially advantageous when the hydrogenation is effected with long residence times of the reaction mixture. Mixing can be effected, for example, using the streams introduced into the reactors, by introducing them into the particular reactors using suitable mixing devices, such as nozzles. Mixing can also be effected using streams from the particular reactor conducted within an external circuit.

To complete the hydrogenation, an output which still comprises hydrogenatable components is withdrawn from each of the first to (n-1)th reactors and is fed into the downstream hydrogenation reactor in each case. In a specific embodiment, the output is separated into a first and a second substream, in which case the first substream is fed back as a circulation stream to the reactor from which it has been withdrawn, and the second substream is fed to the downstream reactor. The output may comprise dissolved or gaseous fractions of hydrogen. In a specific embodiment, the output from the first to (n-1)th reactor is fed to a phase separation vessel and separated into a liquid phase and a gaseous phase, the liquid phase is separated into the first and the second substream, and the gas phase is fed separately at least partly to the downstream reactor. In an alternative embodiment, the output from the first to (n-1)th reactor is fed to a phase separation vessel and separated into a first liquid hydrogen-depleted substream and a second hydrogen-enriched substream. The first substream is then fed back as a circulation stream to the reactor from which it has been withdrawn, and the second substream is fed to the downstream reactor. In a further alternative embodiment, the second to nth reactor is charged with hydrogen not via a hydrogenous feed withdrawn from the upstream reactor but rather with fresh hydrogen via a separate feed line.

The above-described process variant is particularly advantageously suitable for control of the reaction temperature and of the heat transfer between reaction medium, delimiting apparatus walls and environment. A further means of controlling the heat balance consists in regulating the entry temperature of the compound to be hydrogenated. For instance, a lower temperature of the incoming feed generally leads to improved removal of the heat of hydrogenation. When the catalyst activity declines, the entry temperature can be selected at a higher level in order to achieve a higher reaction rate and thus to compensate for the decline in catalyst activity,

Advantageously, it is generally possible in this way to prolong the service life of the hydrogenation catalyst used.

Hydrogenation Step b)

In step b) of the process according to the invention, the muconic acid starting material provided in step a) is at least partly subjected to a reaction with hydrogen in the presence of at least one hydrogenation catalyst Hb) to adipic acid.

Preferably, the hydrogenation catalyst Hb) is selected from Raney cobalt, Raney nickel and Raney copper.

Preferably, the hydrogenation in step b) is effected at a temperature in the range from 50 to 160° C., more preferably 60 to 150° C., most preferably 70 to 140° C.

Step b) can be conducted, for example, using at least one loop reactor. In a specific execution, the conversion in step b) is effected using a combination of at least one loop reactor and at least one downstream tubular reactor. However, it is also possible to manage with one loop reactor. In this execution, it is preferable when two temperature zones are provided in the loop reactor. In this execution too, a tubular reactor operated in straight pass may follow downstream. The hydrogenation in step b) is preferably effected in liquid phase mode or trickle mode.

Hydrogenation Step c1)

Hydrogenation of muconic acid, muconic monoesters and lactones

In a first process variant, the hydrogenation in step c1) is effected using a muconic acid starting material selected from muconic acid, muconic monoesters, lactones of muconic acid and mixtures thereof.

In this process variant, the hydrogenation in step c1) is preferably effected using a hydrogenation catalyst comprising at least 50% by weight of cobalt, ruthenium or rhenium, based on the total weight of the reduced catalyst.

If the hydrogenation is effected using catalysts comprising at least 50% by weight of cobalt, the latter may further comprise especially phosphoric acid and/or further transition metals, preferably copper, manganese and/or molybdenum.

The preparation of a suitable catalyst precursor is known from DE 2321101. This comprises, in the unreduced, calcined state, 40 to 60% by weight of cobalt (calculated as Co), 13 to 17% by weight of copper (calculated as Cu), 3 to 8% by weight of manganese (calculated as Mn), 0.1 to 5% by weight of phosphates (calculated as H₃PO₄) and 0.5 to 5% by weight of molybdenum (calculated as MoO₃). EP 636 409 B1 describes the preparation of further suitable cobalt catalyst precursors consisting to an extent of 55 to 98% by weight of cobalt, to an extent of 0.2 to 15% by weight of phosphorus, to an extent of 0.2 to 15% by weight of manganese and to an extent of 0.2 to 15% by weight of alkali metals (calculated as oxide). Catalyst precursors of this kind can be reduced to the active catalysts comprising metallic cobalt by treatment with hydrogen or mixtures of hydrogen and the inert gases such as nitrogen. These catalysts are unsupported catalysts consisting very predominantly of metal and not comprising any catalyst support.

Hydrogenation of muconic diesters and muconic polyesters

In a first process variant, the hydrogenation in step c1) is effected using a muconic acid starting material selected from muconic diesters, poly(muconic esters) and mixtures thereof.

In this process variant, the hydrogenation in step c1) is preferably effected using a hydrogenation catalyst comprising at least 50% by weight of copper, based on the total weight of the reduced catalyst. Catalysts of this kind are preferably used for the hydrogenation of muconic esters.

Useful catalysts are in principle all homogeneous and heterogeneous catalysts suitable for hydrogenation of carbonyl groups, such as metals, metal oxides, metal compounds or mixtures thereof. Examples of homogeneous catalysts are described, for example, in Houben-Weyl, Methoden der Organischen Chemie [Methods of Organic Chemistry], volume IV/1c, Georg Thieme Verlag Stuttgart, 1980, p. 45-67, and examples of heterogeneous catalysts are described, for example, in Houben-Weyl, Methoden der Organischen Chemie, volume IV/1c, p. 16 to 26.

Preference is given to using catalysts comprising one or more elements from transition groups I and VI to VIII of the Periodic Table of the Elements, preferably copper, chromium, molybdenum, manganese, rhenium, ruthenium, cobalt, nickel or palladium, more preferably copper, cobalt or rhenium.

In the hydrogenation of the muconic diesters, oligoesters and polyesters too, it is possible to use the cobalt-, ruthenium- or rhenium-comprising catalysts already mentioned. It is preferable, however, rather than these catalysts, to use catalysts comprising at least 50% by weight of copper (based on the total weight of the reduced catalyst).

The catalysts may consist solely of active components, or the active components thereof may be applied to supports. Suitable support materials are especially Cr₂O₃, Al₂O₃, SiO₂, ZrO₂, ZnO, BaO and MgO or mixtures thereof.

Particular preference is given to catalysts as described in EP 0 552 463 A1. These are catalysts which, in the oxidic form, have the composition

CuₐAl_{b}Zr_{c}Mn_{d}O,

where a>0, b>0, c≧0, d>0, a>b/2, b>a/4, a>c and a>d, and x denotes the proportion of oxygen ions required per formula unit to give electronic neutrality. These catalysts can be prepared, for example, according to the specifications of EP 552 463 A1, by precipitation of sparingly soluble compounds from solutions comprising the corresponding metal ions in the form of salts thereof. Suitable salts are, for example, halides, sulfates and nitrates. Suitable precipitants are all agents which lead to the formation of those insoluble intermediates that can be converted to the oxides by thermal treatment. Particularly suitable intermediates are hydroxides and carbonates or hydrogencarbonates, and so alkali metal carbonates or ammonium carbonate are used as particularly preferred precipitants. Thermal treatment of the intermediates is effected at temperatures in the range from 500° C. to 1000° C. The BET surface area of such catalysts is between 10 and 150 m²/g.

Additionally suitable are catalysts which have a BET surface area of 50 to 120 m²/g, fully or partly comprise crystals having spinel structure, and comprise copper in the form of copper oxide.

WO 2004/085 356 A1 also describes copper catalysts suitable for the process according to the invention, which comprise copper oxide, aluminum oxide and at least one of the oxides of lanthanum, tungsten, molybdenum, titanium or zirconium, and additionally pulverulent metallic copper, copper flakes, pulverulent cement, graphite or a mixture thereof. These catalysts are particularly suitable for all the ester hydrogenations mentioned.

The hydrogenation in step c1) can be conducted batchwise or continuously, preference being given to a continuous hydrogenation. The hydrogenation in step c1) can be effected in the gas phase or in the liquid phase.

In a specific embodiment, the hydrogenation in step c1) is effected using a hydrogenation apparatus composed of at least 2 reactors or at least one reactor having at least two reaction zones. In that case, the hydrogenation is effected first within a temperature range from 50 to 160° C. and then within a temperature range from 160 to 240° C.

The catalyst hourly space velocity in continuous mode is preferably 0.1 to 2 kg, more preferably 0.5 to 1 kg, of starting material to be hydrogenated per kg of hydrogenation catalyst and hour.

The molar ratio of hydrogen to muconic acid starting material is preferably 50:1 to 10:1, more preferably 30:1 to 20:1. This muconic acid starting material is selected in accordance with the invention from muconic acid, esters of muconic acid, lactones of muconic acid and mixtures thereof.

If the hydrogenation in step c1) is effected using a muconic acid starting material selected from at least two of the aforementioned compounds, the amount of hydrogen used is selected as a function of the proportion of the compounds to be hydrogenated according to the aforementioned assessment rule.

The conversion in the first reactor, based on the adipic acid or adipic ester formed, is preferably at least 70%, more preferably at least 80%.

The overall conversion in the hydrogenation, based on hydrogenatable starting material, is preferably at least 97%, more preferably at least 98%, especially at least 99%.

The selectivity in the hydrogenation, based on hexane-1,6-diol formed, is preferably at least 97%, more preferably at least 98%, especially at least 99%.

Hydrogenation Step c2)

In step c2), the adipic acid obtained in step b) is partly subjected to a reaction with hydrogen in the presence of at least one hydrogenation catalyst Hc2) to hexane-1,6-diol.

Preferably, the hydrogenation catalyst Hc2) used in step c2), based on the total weight of the reduced catalyst, comprises at least 50% by weight of elements selected from rhenium, iron, ruthenium, cobalt, rhodium, iridium, nickel and copper.

For hydrogenation of adipic acid, adipic monoesters and adipic diesters, it is especially preferable that the catalyst Hc2) comprises at least 50% by weight of elements selected from the group consisting of rhenium, ruthenium and cobalt. For hydrogenation of an adipic oligoester or polyester, it is especially preferable that the catalyst c2) comprises at least 50% by weight of copper.

The hydrogenation in step b) is effected preferably at a temperature in the range from 160 to 240° C., more preferably 170 to 230° C., most preferably 170 to 220° C.

Step c2) can be conducted, for example, using at least one loop reactor. In a specific execution, the conversion in step c2) is effected using a combination of at least one loop reactor and at least one downstream tubular reactor. However, it is also possible to manage with one loop reactor. In this execution, it is preferable when two temperature zones are provided in the loop reactor. In this execution too, a tubular reactor operated in straight pass may follow downstream. The hydrogenation in step c2) is preferably effected in liquid phase mode or trickle mode.

Workup of the hexane-1,6-diol from Step c1) or c2)

In a preferred embodiment of the process according to the invention, the output from the hydrogenation in step c1) or c2) is subjected to a distillative separation to obtain a hexane-1,6-diol-enriched fraction, and the hexane-1,6-diol-enriched fraction is used for amination in step d).

In one hydrogenation variant according to step c1), the hydrogenation is effected using muconic acid in water as a solvent. The reaction output obtained in the hydrogenation of muconic acid in step c1) in water as solvent is an aqueous hexane-1,6-diol solution. After the cooling and decompression of the hydrogenation output, the water is preferably removed by distillation, and hexane-1,6-diol can be obtained in high purity (>97%).

If the muconic acid hydrogenation, in one hydrogenation variant according to step c1), is conducted, for example, in methanol as a solvent, a portion of the muconic acid is converted in situ to monomethyl muconate and dimethyl muconate. The hydrogenation output is a solution of hexane-1,6-diol in a mixture of methanol and water. By distillation, methanol and water are separated from hexane-1,6-diol. Methanol is preferably separated from water and recycled into the hydrogenation. Water is discharged.

If n-butanol or i-butanol is used as a solvent in the muconic acid hydrogenation, a liquid biphasic mixture is obtained after the cooling and decompression of the hydrogenation output. The aqueous phase is separated from the organic phase by phase separation. The organic phase is distilled. Butanol is removed as the top product and preferably recycled into the muconic acid hydrogenation. Hexane-1,6-diol can, if necessary, be purified further by distillation.

If muconic diesters are used for hydrogenation, substantially anhydrous solutions of hexane-1,6-diol are obtained, which can be worked up by distillation to give pure hexane-1,6-diol. The alcohols obtained are preferably recycled into the esterification stage.

Hydrogenation of muconic oligo- and polyesters comprising hexane-1,6-diol as the diol component gives a hydrogenation output consisting very predominantly of hexane-1,6-diol.

Step d)

In step d) of the process according to the invention, the hexane-1,6-diol obtained in step c1) or c2) is subjected to an amination in the presence of an amination catalyst to obtain hexamethylenediamine.

In step d), the hexane-1,6-diol is preferably reacted with ammonia in the presence of the amination catalyst to give hexamethylenediamine.

The inventive amination can be conducted without supply of hydrogen, but preferably with supply of hydrogen.

In one embodiment of the invention, the catalysts used are preferably predominantly cobalt, silver, nickel, copper or ruthenium, or mixtures of these metals, “Predominantly” is understood here to mean that one of these metals is present to an extent of more than 50% by weight in the catalyst (calculated without support). The catalysts can be used in the form of unsupported catalysts, i.e. without catalyst support, or in the form of supported catalysts. The supports used are preferably SiO₂, Al₂O₃, TiO₂, ZrO₂, activated carbon, silicates and/or zeolites. Said catalysts are preferably used in the form of fixed bed catalysts. It is also possible to use cobalt, nickel and/or copper in the form of suspension catalysts of the Raney type.

In one embodiment of the invention, the hexane-1,6-diol is aminated in homogeneous phase and the catalyst is a complex catalyst comprising at least one element selected from groups 8, 9 and 10 of the Periodic Table (IUPAC) and at least one donor ligand. Catalysts of this kind are known, for example, from WO 2012/119929 A1.

The amination is effected preferably at temperatures of 100 to 250° C., more preferably 120 to 230° C., most preferably 100 to 210° C.

The total pressure is preferably in the range from preferably 5 to 30 MPa, more preferably 7 to 27 MPa and most preferably 10 to 25 MPa.

The molar ratio of hexane-1,6-diol to ammonia is preferably 1:30, more preferably 1:25, most preferably 1:20.

The amination can be effected without solvent. However, it is preferably conducted in the presence of at least one solvent. Preferred solvents are water, ethers or mixtures of these solvents, and ether is more preferably selected from dioxane, tetrahydrofuran, 2-methyltetrahydrofuran, dioxolane, dibutyl ether and methyl tert-butyl ether.

In a preferred embodiment of the process according to the invention, the aqueous hexane-1,6-diol solutions obtained in the hydrogenation of muconic acid are used in the amination step without workup.

It may be advantageous to fully or partly dewater a portion of the aqueous hexane-1,6-diol obtained in step c1) or c2). In the case of partial dewatering, it is possible, for example, to remove 50%, preferably 70%, more preferably 90%, of the water present in the crude hexane-1,6-diol. This can be effected, for example, by evaporating the water off at 50 to 90° C. under reduced pressure (for example on a rotary evaporator) or by distillation.

In a particularly preferred embodiment, the amination is conducted in the presence of hexamethyleneimine as a solvent or hexamethyleneimine/water mixtures.

The amount of solvent is preferably such as to give rise to 5 to 80%, preferably 10 to 70%, more preferably 15 to 60%, by weight hexane-1,6-diol solutions.

Preferably 10 to 150 liters, more preferably 10 to 100 liters, of hydrogen are supplied per mole of hexane-1,6-diol.

In one embodiment of the invention, the amination of hexane-1,6-diol with ammonia, in a first component step d1), is effected to give a mixture of 1-amino-6-hydroxyhexane and hexamethylenediamine, comprising more than 50% by weight of 1-amino-6-hydroxyhexane. In a component step d2), the latter is separated together with hexamethylenediamine from unconverted hexane-1,6-diol and, in a component step d3), reacted with further ammonia to give hexamethylenediamine.

The amination can be conducted batchwise or continuously, in the liquid or gas phase, preference being given to a continuous process regime.

The workup of the hexamethylenediamine target product still comprising 1-amino-6-hydroxyhexane is preferably effected by distillation. Since 1-amino-6-hydroxyhexane and hexamethylenediamine have very similar vapor pressures, pure hexamethylenediamine is discharged. Mixtures of 1-amino-6-hydroxyhexane and hexamethylenediamine are recycled into the distillation stage.

In a further, particularly preferred embodiment, the hexamethyleneimine formed in the amination of hexane-1,6-diol is separated from the amination output and recycled into the amination stage. If the amount of hexamethyleneimine recycled is 34% by weight (based on the total weight of hexane-1,6-diol and hexamethyleneimine), advantageously no additional hexamethyleneimine is formed. Hexamethyleneimine can be removed by distillation as an azeotrope with water.

The hexamethylenediamine obtained can be subjected to a further purification. This preferably comprises at least one distillation step. In a specific embodiment, the hexamethylenediamine obtained is brought to “fiber quality” (i.e. a hexamethylenediamine content of at least 99.9%) by fractional distillation. If 2-aminomethylcyclopentylamine (AMCPA) and/or 1,2-diaminocyclohexane (DACH), which are compounds isomeric with hexamethylenediamine, are present as by-products, these can be removed according to U.S. Pat. No. 6,251,229 B1 at pressures of 1 to 300 mbar using distillation columns having a low pressure drop.

Step e)

In the process according to the invention, it is possible to synthesize polyamide-6,6 having a C¹⁴/C¹² isotope ratio in the range from 0.5×10⁻¹² to 5×10⁻¹².

In one embodiment of the invention, adipic acid prepared in step b) is polycondensed with the hexamethylenediamine prepared in step d) to give polyamide-6,6. This is preferably effected in the following component steps:
e1) reacting adipic acid and hexamethylenediamine in a molar ratio of essentially 1:1 to give hexamethylenediammonium adipate (AH salt), and
e2) converting the hexamethylenediammonium adipate to polyamide-6,6 at a temperature of not more than 275° C.

In order to achieve high molar masses of the polyamide-6,6, adipic acid and hexamethylenediamine should be combined here as accurately as possible in a molar ratio of 1:1. More particularly, it is possible to work by a method known from Hans-Georg Elias, Makromoleküle [Macromolecules], 4th edition, pages 796 to 797, Hüthig-Verlag (1981).

In another embodiment of the invention, muconic acid prepared in step a) is polycondensed with the hexamethylenediamine prepared in step d) to give polyamide-6,6 (see EP 117048 A2). This is preferably effected in the following component steps:
e1.1) reacting muconic acid and hexamethylenediamine in a molar ratio of essentially 1:1 to give hexamethylenediammonium muconate, and
e1.2) hydrogenating the hexamethylenediammonium muconate to hexamethylenediammonium adipate, and
e2) converting the hexamethylenediammonium adipate to polyamide-6,6.

In order to achieve high molar masses of the polyamide-6,6, muconic acid and hexamethylenediamine should be combined here as accurately as possible in a molar ratio of 1:1.

The conversion of the hexamethylenediammnonium adipate to polyamide-6,6 is effected especially in the presence of water at a temperature of not more than 280° C., more preferably of not more than 275° C.

The invention is illustrated in detail by the nonlimiting examples which follow,

### EXAMPLES

### Example 1

Preparation of Muconic Acid

cis,cis-Muconic acid was prepared by the method in K. M. Draths, J. W. Frost, J. Am. Chem. Soc., 116 (1994), pages 399-400, biocatalytically from D-glucose by means of the Escherichia coli mutant AB2834/pKD136/pKD8.243A/pKD8.292.

### Example 2

Preparation of Adipic Acid

A 250 mL stirred autoclave was charged with a suspension of 24 g of the cis,cis-muconic acid and 1 g of Raney Ni in 56 g of water, hydrogen was injected to 3 MPa and the autoclave was heated to 80° C. On attainment of the temperature of 80° C., the pressure was increased to 10 MPa and a sufficient amount of further hydrogen was metered in to keep the pressure constant. After a reaction time of 12 h, the autoclave was cooled to a temperature of 60° C. and decompressed to standard pressure, and the catalyst was filtered out of the solution. Thereafter, the mixture was cooled gradually to 20° C., in the course of which adipic acid crystallized out as a white solid. In the solution, as well as adipic acid, it was still possible to detect lactone (V). The yield of adipic acid was 95% and that of lactone (V) 5%. The mother liquor comprising adipic acid and lactone (V) is recycled into the hydrogenation stage.

### Example 3

Preparation of hexane-1,6-diol

15 g/h of a mixture of 33% of the adipic acid and 67% water were hydrogenated at a feed temperature of 70° C. in a 30 mL tubular reactor in which 20 mL of catalyst (66% CoO, 20% CuO, 7.3% Mn₃O₄, 3.6% MoO₃, 0.1% Na₂O, 3% H₃PO₄, preparation according to DE 23 21 101 A; 4 mm extrudates; activation with hydrogen up to 300° C.) were present, in trickle mode at a temperature of 230° C. and a pressure of 25 MPa. The reactor output was separated from excess hydrogen in a separator (offgas rate 2 L/h) and passed partly through a pump as circulation stream back to the head of the reactor, where it is combined with the feed stream (feed:circulation=1:10), and partly into an output vessel. The outputs were analyzed by gas chromatography (% by weight, method with internal standard). The yield of hexane-1,6-diol was 94%; the yield of adipic acid was 98.5%. As further products, 3% 6-hydroxycaproic acid, 1% hexane-1,6-diol 6-hydroxycaproate and 1% hexanol were present.

Preparation of hexamethylenediamine:

The preparation of hexamethylenediamine from hexane-1,6-diol based on muconic acid was effected in analogy to U.S. Pat. No. 3,215,742, examples 1 and 2.

### Example 4

Amination of hexane-1,6-diol

The water content of the crude hexane-1,6-diol prepared according to example 3 of this application was lowered to 5% by weight by evaporation at 70° C. and a water-jet vacuum.

193 g of crude hexane-1,6-diol were stirred with the amounts of dioxane, Raney nickel and liquid ammonia described in example 1 in an autoclave at 200° C. and 200 bar for 5 hours. Then the autoclave was cooled and decompressed. The gas chromatography analysis of the reaction output showed that 55% of the hexane-1,6-diol had been converted to a mixture consisting of 65% hexamethylenediamine and 35% hexamethyleneimine.

### Example 5

Amination of mixtures of crude hexane-1,6-diol and hexamethyleneimine

117 g of partly dewatered crude hexane-1,6-diol and 54 g of hexamethyleneimine were dissolved in 50 g of dioxane. This solution was stirred in an autoclave together with 540 g of liquid ammonia and 72 g of Raney nickel at 180 to 183° C. for six hours. The autoclave was cooled and decompressed. The gas chromatography analysis showed that the hexane-1,6-diol conversion was 35%. The hexamethylenediamine yield was 98%, based on hexane-1,6-diol converted.

1.-26. (canceled)

27. A process for preparing polyamide-6,6, comprising
a) Providing a muconic acid starting material selected from muconic acid, esters of muconic acid, lactones of muconic acid and mixtures thereof, in which the muconic acid originates from a renewable source,
b) At least partially subjecting the muconic acid starting material provided in step a) to a reaction with hydrogen in the presence of at least one hydrogenation catalyst Hb) to adipic acid,
c1) Partially subjecting the muconic acid starting material provided in step a) to a reaction with hydrogen in the presence of at least one hydrogenation catalyst Hc1) to hexane-1,6-diol,
or
c2) Partially subjecting the adipic acid obtained in step b) is to a reaction with hydrogen in the presence of at least one hydrogenation catalyst Hc2) to hexane-1,6-diol,
d) Subjecting the hexane-1,6-diol obtained in step c1) or c2) to an amination in the presence of an amination catalyst to obtain hexamethylenediamine,
e) Subjecting at least a portion of the adipic acid obtained in step b) and the hexamethylenediamine obtained in step d) to a polycondensation to obtain polyamide-6,6,
wherein the hydrogenation in at least one of steps b) and/or c1) and/or c2) is effected in the liquid phase in the presence of water as solvent.

28. The process according to claim 27, wherein the muconic acid starting material is provided in step a), in which the muconic acid originates from a renewable source, and is prepared by biocatalytic synthesis from at least one renewable raw material.

29. The process according to claim 27, wherein the muconic acid used in step a) has a ¹⁴C-to-¹²C isotope ratio in the range from 0.5×10⁻¹² to 5×10⁻¹².

30. The process according to claim 27, wherein the hydrogenation in step b) and/or in step c1) is effected using a muconic acid starting material selected from muconic acid, muconic monoesters, muconic diesters, poly(muconic esters) and mixtures thereof.

31. The process according to claim 27, wherein the hydrogenation in step c1) is effected using a muconic acid starting material selected from the lactones (III), (IV) and (V) and mixtures thereof:

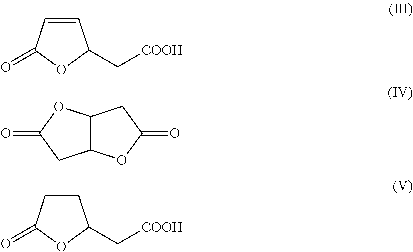

32. The process according to claim 27, wherein the hydrogenation catalyst Hb) includes at least one transition metal selected from the group of Co, Ni, Cu, Re, Fe, Ru, Rh and Ir.

33. The process according to claim 27, wherein the hydrogenation catalyst Hb) is selected from the group consisting of Raney cobalt, Raney nickel and Raney copper.

34. The process according to claim 27, wherein the hydrogenation in step b) is effected at a temperature within the range from 50 to 160° C.

35. The process according to claim 27, wherein the hydrogenation in at least one of steps b) and/or c1) and/or c2) is effected in the liquid phase in the presence of water as the sole solvent.

36. The process according to claim 27, wherein the catalyst is in the form of a heterogeneous catalyst under the hydrogenation conditions in at least one of steps b) and/or c1) and/or c2).

37. The process according to claim 27, wherein the hydrogenation in at least one of steps b), c1) and c2) is effected in the liquid phase, and the catalyst is in the form of a suspension.

38. The process according to claim 27, wherein the hydrogenation in step c1) is effected in the liquid phase in the presence of a solvent selected from water, aliphatic C₁ to C₅ alcohols, aliphatic C₂ to C₆ diols, ethers and mixtures thereof.

39. The process according to claim 27, wherein the hydrogenation in step c1) is effected in the liquid phase in the presence of water as the sole solvent.

40. The process according to claim 27, wherein the hydrogenation in step c1) is effected using a muconic diester selected from compounds of the general formula (II):
R′OOC—CH═CH—CH═CH—COOR² (II)
in which the R¹ and R² radicals are each independently straight-chain or branched C₁-C₅-alkyl, wherein the hydrogenation in step c1) is effected in the gas phase.

41. The process according to claim 27, wherein the hydrogenation catalyst Hc1) used in step c1) is a heterogeneous transition metal catalyst.

42. The process according to claim 27, wherein
in step c1) a muconic acid starting material is used, selected from muconic acid, muconic monoesters, lactones of muconic acid and mixtures thereof, and a heterogeneous hydrogenation catalyst Hc1) is used, comprising at least 50% by weight of cobalt, ruthenium or rhenium, based on the total weight of the reduced catalyst, or
in step c1) a muconic acid starting material is used, selected from muconic diesters, poly(muconic esters) and mixtures thereof, and a heterogeneous hydrogenation catalyst Hc1) is used, comprising at least 50% by weight of copper, based on the total weight of the reduced catalyst.

43. The process according to claim 27, wherein the hydrogenation catalyst Hc2) used in step c2), based on the total weight of the reduced catalyst, comprises at least 50% by weight of elements selected from group consisting of rhenium, iron, ruthenium, cobalt, rhodium, iridium, nickel and copper.

44. The process according to claim 27, wherein the hydrogenation in step c2) is effected at a temperature within the range from 160 to 240° C.

45. The process according to claim 27, wherein adipic acid-containing water which is obtained in the isolation of the hydrogenation catalyst Hc2) on completion of step c2) is used as solvent in step b).

46. The process according to claim 27, wherein the hydrogenation in step b) and/or the hydrogenation in step c1) and/or the hydrogenation in step c2) is/are conducted in n series-connected hydrogenation reactors, where n is an integer of at least two, and wherein the 1st to (n-1)th reactor has a stream from the reaction zone which is conducted within an external circuit and the hydrogenation in the nth reactor is conducted adiabatically.

47. The process according to claim 27, wherein the hexane-1,6-diol obtained in step c1) or in step c2) is reacted in step d) with ammonia in the presence of the amination catalyst to give hexamethylenediamine.

48. The process according to claim 27, wherein the amination in step d) is conducted without or with supply of hydrogen.

49. The process according to claim 27, wherein the reaction output from the amination in step d) is subjected to a separation to obtain a hexamethyleneimine-enriched and a hexamethylenediamine-depleted fraction, and the hexamethyleneimine-enriched fraction is recycled into the amination in step d).

50. The process according to claim 27, wherein hexamethyleneimine is used as the sole solvent in step d).

51. A polyamide-6,6 having a C¹⁴/C¹² isotope ratio in the range from 0.5×10⁻¹² to 5×10⁻¹².

52. A polyamide-6,6 preparable proceeding from muconic acid synthesized biocatalytically from at least one renewable raw material.
